(19) United States
(12) Patent Application Publication
(10) Pub. No.: US 2020/0233481 A1
(43) Pub. Date: Jul. 23, 2020

(54) METHOD FOR SWITCHING OPERATION MODE BY ONE KEY

(71) Applicant: Hangzhou Yele Technology Co., Ltd., Hangzhou (CN)

(72) Inventor: Wei Tang, Hangzhou (CN)

(73) Assignee: Hangzhou Yele Technology Co., Ltd., Hangzhou (CN)

(21) Appl. No.: 16/298,359

(22) Filed: Mar. 11, 2019

(30) Foreign Application Priority Data
Jan. 17, 2019 (CN) 201910043528.X

(51) Int. Cl. G06F 1/3234

(52) U.S. Cl. CPC G06F 1/3234

(57) ABSTRACT

A method for switching an operation mode by one key may include that a central controller sets three operation modes: a test mode, a shipping mode, and a normal usage mode. The central controller connects a control key, and three operation modes switch mode in sequence by a button rule of the control key. When the central controller leaves a factory, a test mode button rule is inputted, and the central controller is set as the test mode. In the test mode, a shipping mode button rule is inputted, the central controller issues a command of switching the shipping mode, and a system enters the shipping mode. The present invention sets up a control key that can switch different modes through a specific button mode, which can have simple operation and low error probability, improve the convenience and efficiency of production.

### RELATED APPLICATION INFORMATION

This Non-provisional application claims priority under 35 U.S.C. § 119(a) on Chinese Patent Application No(s). 201910043528.X filed on Jan. 17, 2019, the entire contents of which are hereby incorporated by reference.

### FIELD OF THE DISCLOSURE

The present disclosure relates generally to automation fields, and more particularly, to a method for switching an operation mode by one key.

### BACKGROUND OF THE DISCLOSURE

The existing production mode of shared devices (such as shared scooters), one is to build a background software to operate a central controller terminal through the network; the other is to configure the Bluetooth terminal on-site scanning device to operate. The first drawback is that the background response is not timely, the equipment (shared scooter) factory production cannot be on-site unlocked test or locked test, or the production adopts the test mode, and the operation mode needs to be changed to the operation mode by brushing the program again. The second drawback is that there are large number of terminal devices in the actual production, but there are cases where the Bluetooth pairing is difficult or even wrong, which leads to the problem of a factory terminal device mode conversion error. The market needs a mode switching method with simple operation and low error probability. The present invention solves such problems.

The statements in this section merely provide background information related to the present disclosure and may not constitute prior art.

### SUMMARY

To solve the deficiencies of the prior art, the object of the present invention is to provide a method for switching an operation mode by one key. To set up a control key that can switch different modes through a specific button mode, which can have simple operation and low error probability, improve the convenience and efficiency of production.

To achieve the above objectives, the present invention adopts the following technical plans.

A method for switching an operation mode by one key may include that the central controller sets three operation modes: a test mode, a shipping mode, and a normal usage mode; the central controller connects a control key, and three operation modes switch mode in sequence by a button rule of the control key; when the central controller leaves a factory, a test mode button rule is inputted, and the central controller is set as the test mode; in the test mode, a shipping mode button rule is inputted, the central controller issues a command of switching the shipping mode, and a system enters the shipping mode; in the shipping mode, a normal usage mode button rule is inputted, the central controller is switched to the normal usage mode.

In the foregoing method, products are produced in the test mode, the control key is used as a function key for testing function, unless the shipping mode button rule is inputted.

In the foregoing method, the shipping mode includes that a device only connects with power supply of the control key, the other power supplies are closed, and the central controller enters a low power state, unless the normal usage mode button rule is inputted.

In the foregoing method, in the normal usage mode, the control key is ignored.

In the foregoing method, the test mode button rule is short press for 5 times and long press for 5 seconds.

In the foregoing method, the shipping mode button rule is long press for 10 seconds.

In the foregoing method, the normal usage mode button rule is a long press.

The benefits of the present invention are that the present invention sets up a control key that can switch different modes through a specific button mode, which can have simple operation and low error probability. In the test mode, the control key is used as a switch function key. The workers can perform various functional tests according to production requirements. In the shipping mode, the other power supplies are closed on the device and the central controller enters the low power state, which is beneficial for long-term transportation and storage. After entering the normal usage mode, the control key is ignored, and will not affect normal use. The mode switches quickly, operates simply and improves the convenience and efficiency of production.

### BRIEF DESCRIPTION OF THE DRAWINGS

FIG. 1 is a flowchart of an embodiment of the present invention;

FIG. 2 is a structure chart of an embodiment of the present invention applies to a shared device.

The drawings described herein are for illustrative purposes only of exemplary embodiments and not all possible implementations and are not intended to limit the scope of the present disclosure. Corresponding reference numerals indicate corresponding parts throughout the several views of the drawings.

### DETAILED DESCRIPTION

The following description of the preferred embodiments is merely exemplary in nature and is in no way intended to limit the invention, its application, or uses.

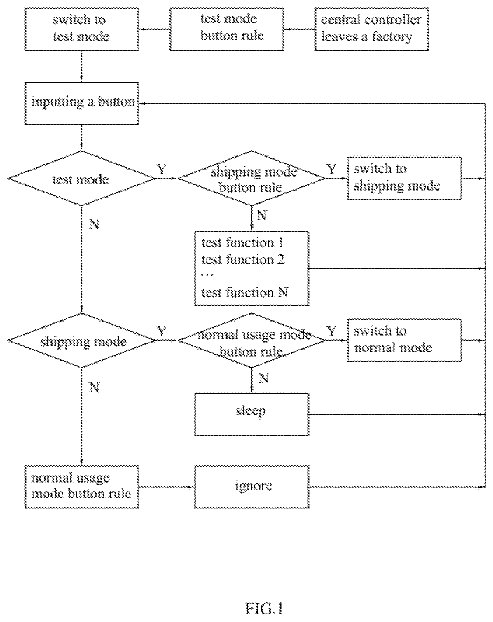

As shown in FIG. 1, a method for switching an operation mode by one key may include that a central controller sets three operation modes: a test mode, a shipping mode, and a normal usage mode. The central controller connects a control key, and three operations mode switch mode in sequence by a button rule of the control key.

The central controller leaves a factory, a test mode button rule is inputted, the central controller is set as the test mode. As an embodiment, the test mode button rule is short press for 5 times and long press for 5 seconds.

Products are produced in the test mode, the control key is used as a function button for testing function, unless a shipping mode button rule.

In the test mode, the shipping mode button rule is inputted, the central controller issues a command of switching the shipping mode, and a system enters the shipping mode. As an embodiment, the shipping mode button rule is long press for 10 seconds.

In the shipping mode, a device only connects with power supply of the control key, the other power supplies are closed, and the central controller enters a low power state, unless the normal usage mode button rule is inputted.

In the shipping mode, a normal usage mode button rule is inputted, the central controller is switched to the normal usage mode. As an embodiment, the normal usage mode button rule is a long press.

In the normal usage mode, the control key is ignored.

The button rules can be set arbitrarily. As long as the rules that can be applied to the method are within the protection scope of the present invention, and the button rules are not enumerated, that should be noted.

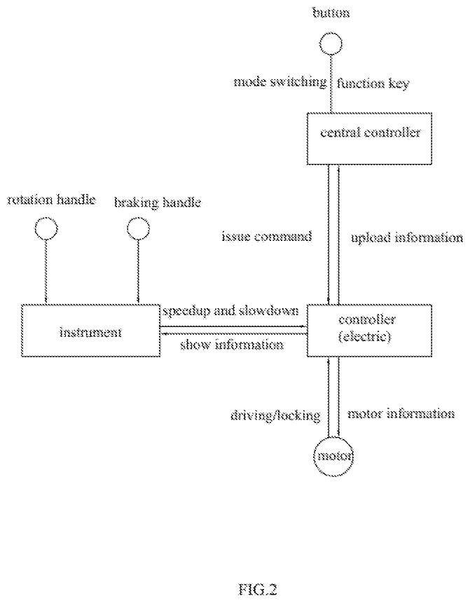

As shown in FIG. 2, after a body of the central controller is powered on, a button is detected by a software, and if it is the test mode button rule (such as, short press for 5 times and long press for 5 seconds), the device enters the test mode. An operating content of the test mode may include: test function 1, test function 2 . . . test function N in sequence. At this point, the button can be used as a switch function key. The workers can perform various functional tests according to production requirements.

The device enters the shipping mode according to the shipping mode button rule (such as, long press for 10 seconds) after tests are finished. At this point, the device only connects with power supply of the control key, the other power supplies are closed, and the central controller enters a low power state, which is beneficial for long-term transportation and storage.

In the normal usage mode, the control key is ignored. When shared devices arrive at the operational end and put on markets, the control key is pressed by the normal usage mode button rule (such as long press), and the device enters the normal usage mode. After entering the normal usage mode, the control key is ignored. No matter how you press it, it works no longer.

The present invention sets up the control key that can switch different modes through a specific button mode, which can have simple operation and low error probability, improve the convenience and efficiency of production.

The above illustrates and describes basic principles, main features and advantages of the present invention. Those skilled in the art should appreciate that the above embodiments do not limit the present invention in any form. Technical solutions obtained by equivalent substitution or equivalent variations all fall within the scope of the present invention.

What is claimed is:

1. A method for switching an operation mode by one key, comprising:
three operation modes set by a central controller: a test mode, a shipping mode, and a normal usage mode;
a control key connected by the central controller, and three operation modes which switching mode in sequence by a button rule of the control key;
inputting a test mode button rule and setting the central controller as the test mode when the central controller left from a factory;
inputting a shipping mode button rule, issuing a command of switching the shipping mode by the central controller, and entering a system into the shipping mode when in the test mode; and
inputting a normal usage mode button rule and switching the central controller to the normal usage mode when in the shipping mode.

2. The method of claim 1, wherein products are produced in the test mode, the control key is used as a function key for testing function, unless the shipping mode button rule is inputted.

3. The method of claim 1, wherein in the shipping mode, a device only connects with power supply of the control key, the other power supplies are closed, and the central controller enters a low power state, unless the normal usage mode button rule is inputted.

4. The method of claim 1, wherein in the normal usage mode, the control key is ignored.

5. The method of claim 1, wherein the test mode button rule is short press for 5 times and long press for 5 seconds.

6. The method of claim 1, wherein the shipping mode button rule is long press for 10 seconds.

7. The method of claim 1, wherein the normal usage mode button rule is a long press.
